(19) United States
(12) Patent Application Publication
(10) Pub. No.: US 2022/0047962 A1
(43) Pub. Date: Feb. 17, 2022

(54) TACTILE PLAY COMPOUND WITH 3D STEREOSCOPIC ILLUSIONS

(71) Applicant: WeCool Toys, Inc., Point Pleasant, NJ (US)

(72) Inventors: Jeffrey Osnato, Medford, NJ (US); Ross Alber, Medford, NJ (US); Eileen Bonaccorso, Medford, NJ (US)

(21) Appl. No.: 16/948,068

(22) Filed: Aug. 31, 2020

Related U.S. Application Data
(60) Provisional application No. 62/706,351, filed on Aug. 11, 2020.

(51) Int. Cl. A63H 33/22; H04N 13/337; G02C 7/12; G02B 30/25

(52) U.S. Cl. CPC A63H 33/22; H04N 13/337; G02B 5/3033; G02B 30/25; G02C 7/12

(57) ABSTRACT

A play compound includes additives, which when viewed with 3D glasses, elicit three-dimensional stereoscopic illusions. To present stereoscopic images, the additives in the play compound are viewed through different polarizing filters of low-cost eyeglasses worn by a viewer. As each filter passes only that light which is similarly polarized and blocks the light polarized in the opposite direction, each eye sees a different image. This is used to produce a three-dimensional effect by projecting the same scene into both eyes but depicted from slightly different perspectives. Multiple persons can view the stereoscopic images at the same time.

### CROSS REFERENCE TO RELATED APPLICATIONS

This application claims priority under 35 U.S.C. § 119 to provisional patent application U.S. Ser. No. 62/706,351, filed Aug. 11, 2020. The provisional patent application is herein incorporated by reference in its entirety, including without limitation, the specification, claims, and abstract, as well as any figures, tables, appendices, or drawings thereof.

### FIELD OF THE INVENTION

The present invention relates generally to an apparatus and corresponding method of use in at least the toy industry. More particularly, but not exclusively, the present invention relates to a tactile play compound having additives, which when used in combination with polarization glasses, will produce three-dimensional stereoscopic illusions.

### BACKGROUND OF THE INVENTION

The background description provided herein is for the purpose of generally presenting the context of the present disclosure. Work of the presently named inventors, to the extent the work is described in the present disclosure, as well as aspects of the description that may not otherwise qualify as prior art at the time of filing, are neither expressly nor impliedly admitted as prior art.

Children love toys. For children, toys are more than just fun and games. Most toys provide at least some opportunity for children to learn. The best toys engage the senses, spark imaginations and encourage children to interact with others.

From a very early age, children are eager to learn more about the world around them. Every new shape, color, texture, taste, and sound presents an opportunity to learn more. Parents quickly identify giving their children toys that are safe and stimulating will help their children discover their senses. Rattles and toys that make music are favorites of infants. Toys with contrasting colors are fascinating to babies and stimulate their developing vision. As they grow, infants can use toys to explore object permanence and cause and effect relationships. They also need objects such as blocks to help them build motor skills and hand-eye coordination.

Toddlers can play with a wider variety of toys than infants. Toddlers may still enjoy some of the toys they played with as babies, however they also need that are designed with their increased capability to learn in mind. Even the same blocks they played with previously can provide them with new and different educational opportunities as their knowledge expands. Shape sorters are great for toddlers. They teach them how to match similar items and provide parents the opportunity to teach them the names of the shapes. Lego® blocks, for example, provide an opportunity to learn more about colors and symmetry developing a child's motor skills.

When children reach schooling age, parents and teachers shift their focus from helping children discover their senses to developing a child's aptitude for lingual (e.g., written and spoken), numeric, memorial, and social skills. There are a lot of toys that encourage this type of learning, from simple alphabet puzzles to high-tech electronic gadgets. These toys help give children a head start by introducing them to the things they will be learning in school. Kids who are in school can supplement their learning with recreational and educational toys. Giving children the opportunity to have fun while practicing the things they are learning in school will increase their retention of those things.

The act of collecting toys offers an opportunity for a child to make an emotional connection with their toys. Not surprisingly, the value a child assigns to any given collection is not monetary but sentimental. The collections allow children to relive previous experiences and connect themselves to a period or to a time they feel strongly about. This in effect helps ease insecurity and anxiety and allows the past to continue to exist in the present. Some children collect for the thrill of the hunt. For these children, collecting is a quest, and may develop into a lifelong pursuit which can never be completed. When children collect, they experiment with arranging, organizing, and presenting a part of the world which may serve to provide a safety zone, a place of refuge where fears are calmed, and insecurity is managed. Motives are not mutually exclusive, rather, different motives combine for each collector for a multitude of reasons.

It is often a challenge for toy developers to design a collection which can be used for a purpose other than simply collecting the item itself, such as stimulating the child's senses while the child is playing with the toy collection or challenging the child's aptitude for continued learning. For example, water balloons and water bombs are toys which can stimulate a child's senses and engage the child's aptitude for continued learning while the child is playing with the toy, however the child is left with nothing to collect after a water balloon war but latex rubber that must be discarded in the trash. In another example, trading cards are collectable toys which are limited in their ability to stimulate a child's senses during play. In yet another example, dolls are collectable toys which are limited in their ability to challenge the child's aptitude for continued learning.

Thus, there exists a need in the art for toy(s) which address these issues and do not rely on the use of expensive, high-tech electronic gadgets.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, or advantage of the present invention to improve on or overcome the deficiencies in the art.

It is still yet a further object, feature, or advantage of the present invention to provide a toy that utilizes three dimensional illusions to stimulate a child's senses.

It is still yet a further object, feature, or advantage of the present invention to provide a child the ability to play with the toy while playing with other children. For example, a means for engaging social media may be provided with the toy.

It is still yet a further object, feature, or advantage of the present invention to provide a toy that may be played with in a wide variety of applications. For example, children can salvage collectable items from the play compound to form a collection, play with individual components of the toy, or form new toys through the assembly of different components of the toy.

It is still yet a further object, feature, or advantage of the present invention to provide a toy that is safe (e.g., non-toxic), cost effective, and durable.

It is still yet a further object, feature, or advantage of the present invention to provide a toy that is aesthetically pleasing.

It is still yet a further object, feature, or advantage of the present invention to practice methods which facilitate use, manufacture, assembly, and repair of a toy accomplishing some or all of the previously stated objectives.

It is still yet a further object, feature, or advantage of the present invention to incorporate a toy into a system or kit accomplishing some or all of the previously stated objectives.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 show a front elevation view which emphasizes external aspects of an exemplary kit for creating three-dimensional stereoscopic illusions which includes a tactile play compound.

FIG. 2 shows an internal view internal view of the product packaging, emphasizing aspects of the play compound.

FIG. 3 shows an internal view of the lid of the bucket, said lid having dividers for storing components in separate compartments prior to initially opening the product packaging.

FIG. 4 shows a child viewing three-dimensional stereoscopic illusions by observing the play compound through stereoscopic glasses.

An artisan of ordinary skill need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

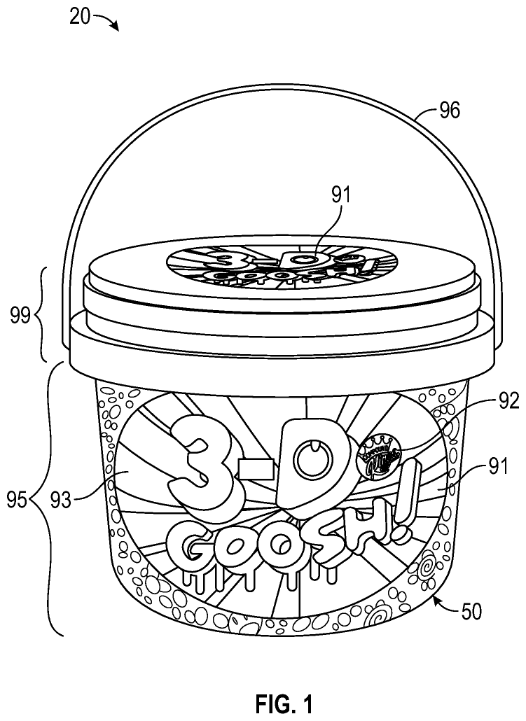

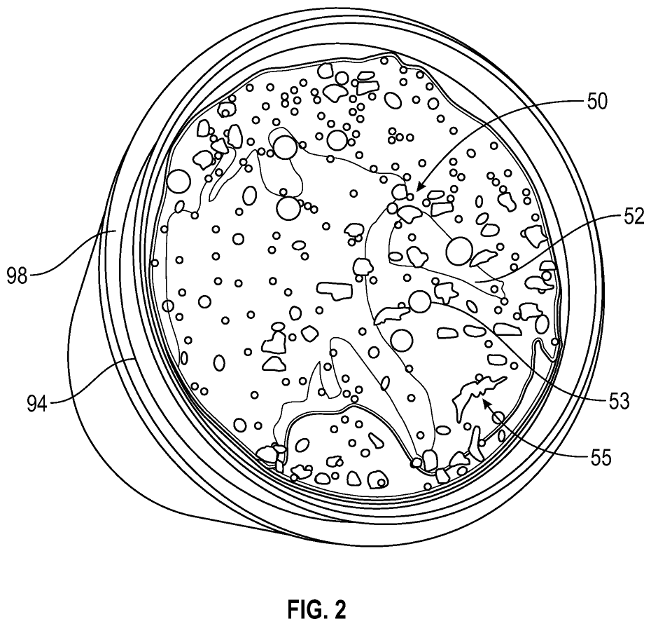

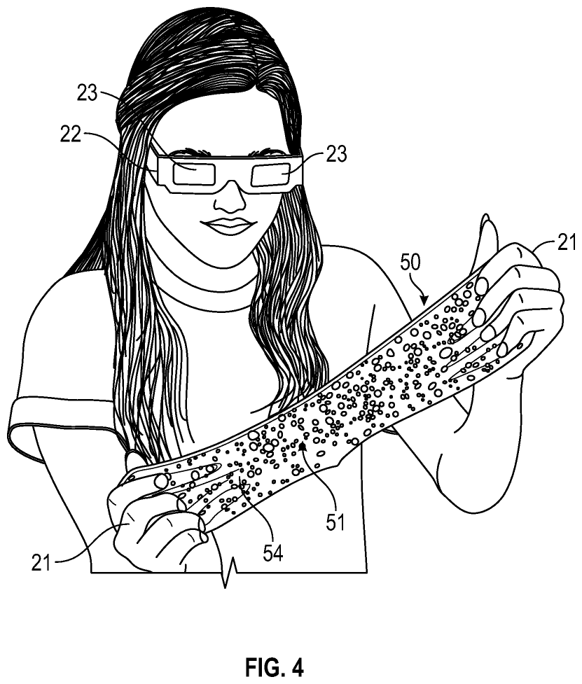

FIGS. 1-4 show a kit 20 which includes a play compound 50 and product packaging 90 for storing the same. The kit 20 uses various components to create three dimensional stereoscopic illusions.

The play compound 50, in particular, includes additives 51, which when viewed with 3D glasses 22, elicit three-dimensional stereoscopic illusions. To present stereoscopic illusions and/or images to the user, the additives 51 in the play compound 50 can be viewed through different polarizing filters 23 of 3D glasses 22. As each filter 23 passes only that light which is of a particular color and/or is similarly polarized and blocks other colors of light and/or light polarized in the opposite direction, each eye sees a different image. This is used to produce a three-dimensional effect by projecting the same scene into both eyes but depicted from slightly different perspectives. There is no limit as to how many persons can view the stereoscopic effects at the same time.

In preferred embodiments, the 3D glasses 22 utilize anaglyph 3D, the stereoscopic 3D effect achieved by means of encoding each eye's image using filters of different (usually chromatically opposite) colors, which are typically red and cyan. Other suitable pairs of colors may be used, including but not limited to: red-green, red-blue, green-magenta, dark red-cyan, amber-dark blue, and magenta-cyan.

When viewed through the color-coded anaglyph glasses 22, each of the two images reaches the intended eye of the wearer, revealing an integrated stereoscopic image and allowing the visual cortex of the brain to perceive this as a three-dimensional scene. Low cost paper frames or plastic-framed glasses typically hold the color filters 23.

Alternatively, the 3D glasses 22 can be either linearly polarized or circularly polarized. The filters 23 are optical filters that let light waves of a specific polarization pass through while blocking light waves of other polarizations. In some embodiments, the filters 23 of the 3D glasses 22 will primarily function by absorbing unwanted polarization states of light passing therethrough. In other embodiments, the filters 23 of the 3D glasses 22 will primarily function by splitting beams of light into two beams with opposite polarization states.

Tourmaline, herapathite, and/or other suitable crystals that show dichroism can be used as linear polarizers. Other suitable filters 22 include polyvinyl alcohol-iodine complex polarizers, such as those commonly sold by Polaroid Corporation under the trade name Polaroid®. The Polaroid® filter comprises a unidirectionally stretched, linearly oriented poyvinylalcohol sheet, supported on a suitable substrate, isotropic plastic material (e.g., cellulose acetate butyrate), and stained with a polyiodide solution. Such polarizers are commonly available from Polaroid Corporation as type H polarizer sheets, varieties thereof being described in U.S. Pat. Nos. 2,173,304; 2,225,940; 2,306,108; 2,397,231; 2,453,186; and 2,674,159.

The Polaroid® filter stretches the sheet during manufacture thereby causing the PVA chains to align in one particular direction. Valence electrons from the iodine dopant are able to move linearly along the polymer chains, but not transverse to them. So incident light polarized parallel to the chains is absorbed by the sheet; light polarized perpendicularly to the chains is transmitted. The durability and practicality of Polaroid® filter makes it the most common type of polarizer in use, for example for sunglasses, photographic filters, and liquid crystal displays. It is also much cheaper than other types of polarizer.

According to some other aspects, it can be preferred to maintain the same axes of polarization with varying angles of incidence. Associated polarization vectors can thus be described with simple Cartesian coordinates (e.g., horizontal vs. vertical) independent from the orientation of the polarizer surface. The overall kit 20 can be configured and/or position such that the two polarization states are relative to the direction of a surface, thereby achieving high contrast and with wide angular spreads of the incident light.

Anatomically, there are three levels of binocular vision required to view stereo images through the 3D glasses 92: (a) simultaneous perception; (b) fusion (binocular ‘single’ vision); and (c) stereopsis. These functions develop in early childhood. Some people who have strabismus disrupt the development of stereopsis, however orthoptics treatment can be used to improve binocular vision.

A child's stereoacuity determines the minimum image disparity they can perceive as depth when the child uses polarization glasses 22. For polarization with a red and cyan lens. The eye covered by the red lens will perceive red as “white” and cyan as “black,” and vice versa for the other eye. This disparity mimics what each eye would see in reality, as with most 3D technology. When viewed without the polarization glasses 22, the play compound 50 may look blurry and discolored.

The play compound 50 is a material of the type for use in play and/or crafts and can be non-toxic. Some play compounds of this type conventionally include a cross-linked polymer, such as an adhesive, such as white glue, and which is manufactured under factory conditions by combining polyvinyl alcohol solutions with borate ions. The play compound 50 can be odorless or a particular odor can be added to the same. The play compound 50, which is liquid or at least semi fluid, can be formed of a particular color. The play compound 50 typically feels cold and slimy when touched by a user's hands. The play compound 50 can be referred to as a non-Newtonian fluid in that the viscosity of the fluid can be affected by factors other than temperature, such as by the application of a shear stress caused by any of squeezing, stirring, agitating or applying mechanical pressure to the play compound 50.

The play compound 50 can be formed from a plurality of different powder types and water. The different powder types can be selectively used alone or in combination to form a particular play compound. The powders may differ in terms of any or any combination of color; consistency; ingredients; additional decorative additives 53 (which in some embodiments, will also serve as devices 51 which emit stereoscopic illusions when viewed through the 3D glasses 22) such as glitter, small plastic hearts or stars, and the like. Ingredients of the powder include gum, such as Guar gum, Borax (or another borate); a colorant 52, such as a suitable color pigment, combination of color pigments, and/or a luminescent; starch; a phosphate such as Sodium Hydrogen phosphate; an ethanol; and/or an acetate such as Sodium dehydroacetate. In a specific embodiment, a borate is not included. Any one or more of the ingredients may provide a visual and/or a tactile effect. Tactile effects affect how an object feels to a person when touching the object. Visual effects affect how an object appears to a person when looking at the object and can include the means for eliciting three-dimensional stereoscopic illusions. Non-limiting examples of other visual effects include changing the color of an object; increasing or decreasing color contrast between adjacent objects; increasing or decreasing an object's reflectivity; and emitting light with an object such as a light bulb or a phosphor.

Particular colorants 52 may be selected depending on pairs of colors used for filters 23. For example, if red/green anaglyph glasses 22 are used, blue and yellow colorants 52 may be used so as to exacerbate the stereoscopic effect of the play compound 50 and/or objects located therewithin. Moreover, location of additives 51 and/or colorants 52 within the play compound 50 may be selectively positioned in accordance with computer programs configured to exacerbate stereoscopic effects. To determine how to best exacerbate such effects, mosaicking or image stitching can be used. Said mosaicking or image stitching processes can be aided by image processing computer programs that simulate the effects of using color filters (or even other types of filters, e.g., polarization).

Ratio(s) of each provided ingredient of the play compound 50 are linked to a particular composition of the play compound 50 which will be provided. For example, if there is a greater quantity of powder added to an amount of liquid, then the play compound 50 will have greater viscosity and/or other characteristic. If a smaller quantity of powder is added to the amount of liquid, the play compound 50 will have a lower viscosity and/or other characteristic. Each of the compounds can be linked to a particular identifiable type or characteristic of play compound such as, clay, dough, rubber, certain resins, sand, gel, slimy substance and/or other art/craft compound. The specific ingredients or additives 51 contained within the play compound are typically provided in set percentages under factory conditions. However, the composition of the play compound may be later altered by a user with other ingredients and/or additives to make a new play compound with at least some user selected characteristics.

To play with the play compound 50 individually, the play compound 50 can be manipulated by the user's hands 21 to take selected forms such as a stretch form 54 and a compact form 55. Different stereoscopic illusions can be viewed in the play compound 50 during and/or after manipulation of the same.

When manipulated, the play compound 50 can be described as having a bubbly, stretchy, glitzy, and/or cracking nature. Children will appreciate the play compound 50, is partially elastic and once moved into a particular shape, has a tendency to stay in that shape until further manipulated by the child. This type of compound 50 and the manipulation of the same can provide entertainment for many hours to children.

According to some other aspects of the present disclosure, a child may use the toy system or kit 20 with their friends or to engage social media. For example, children can share with other children use of the play compound 50 and/or the contents of their collection, which may potentially lead to children trading ideas for further play and/or even items of their collection to other children.

Persons may be broadcasted on a social media platform opening selected replicas to salvage treasure contained therein. The social media platform may be accessed through a network. The network could, for example, be a wide area network (“WAN”), a TCP/IP based network, a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Optionally included with the play compound 50 is product packaging 90, as shown throughout the figures. The packaging 90 typically is in the form of a transparent or translucent bucket with a handle 96 for carrying the play compound 50 from one location to the next.

The packaging 90 can comprise plastics, thermoplastics, glass, wood, wood wool, paper, paperboard, corrugated cardboard, other biodegradable or recyclable materials, or the like. The packaging 90 can comprise a product identifier 91, such as a word or trade mark, on the packaging 90; image(s) 92, such as those used to market the kit 20 to children; a viewing window (or substantially transparent portion) for viewing at least one component and/or the entirety of the toy system or kit 20 on or near the packaging 90; instructions and/or warnings 93 for using a part or all of the toy system or kit; and a means from which the packaging can be hung, such as handle 96, or otherwise easily displayed on shelves in public stores, where the toy system or kit is then marketed to children.

Instructions and/or warnings 93 may instruct the wearer not to use and/or to stop using the anaglyph glasses 22 for an extended period of time so as to cause discomfort. Wearers may be warned the afterimage caused by the colors of the glasses may temporarily affect the viewer's visual perception of real life objects. Instructions 93 may also suggest certain methods and/or steps for manipulating the play compound 50 so as to create certain types of stereoscopic illusions.

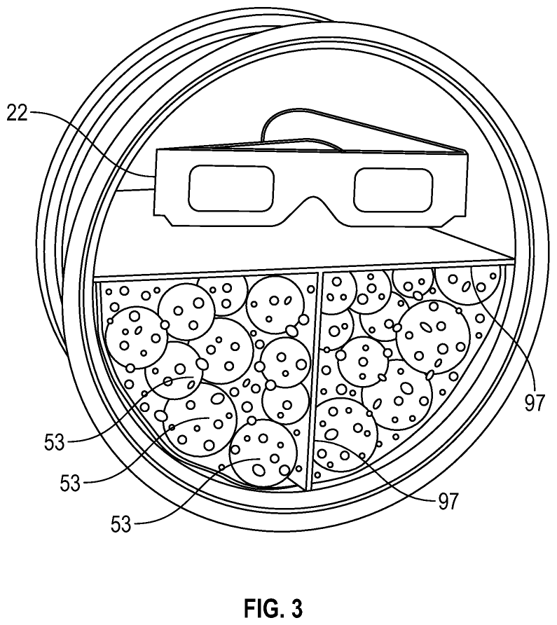

The bucket/packaging 90 is initially sealed and is prevented from being opened until a tab 94 located near the rim 98 is broken. The rim 98 can be, but is not limited to, located at an upper circumferential edge of the main compartment 95 and/or a lower circumferential edge of the lid 99. The lid 99 of the product packaging 90 preferably includes dividers 97 attached to a lower surface of the lid 99 so as to house individual components of the toy system. These individual compartments can be used to store components such as the 3D glasses 22, replacement 3D glasses 22, replacement filter(s) 23, additives 51 for the play compound 50, other trinkets, etc. Other trinkets, such as the pom-poms shown in FIG. 3 may or may not also elicit three-dimensional stereoscopic illusions if used in conjunction with 3D glasses 22.

From the foregoing, it can be seen that the present invention accomplishes at least all of the stated objectives. While both anaglyph and polarizing systems can be utilized, it should still be appreciated there will exist embodiments where active-shutter and/or lenticular systems, especially those which employ the product packaging 90 as a means for bending light, can be used. Some of these systems will not require the use of 3D glasses 22.

### LIST OF REFERENCE CHARACTERS

The following reference characters and descriptors are not exhaustive, nor limiting, and include reasonable equivalents. If possible, elements identified by a reference character below and/or those elements which are near ubiquitous within the art can replace or supplement any element identified by another reference character.
20 toy system or kit
21 hands
22 3D glasses
23 filters
50 play compound
51 stereoscopic illusory emitting devices
52 colorants (e.g., dyes, pigments or powders, etc.)
53 decorative additives (e.g., glitter, hearts, stars, etc.)
54 stretch form
55 compact form
90 packaging/bucket
91 product identifier
92 image(s)
93 instructions
94 breakable tab/seal
95 main compartment
96 handle/hanging element
97 minor compartments
98 rim
99 lid

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The term “play” can be used herein as an adjective, a verb, a noun, or any other suitable part of speech given proper context. As an adjective, “play” means relating to an activity engaged in for enjoyment and recreation, especially by children. Similarly, as a verb, to play means to engage in a game or activity for enjoyment or recreation. As a noun, play refers to an activity engaged in for enjoyment and recreation. For example, a play compound may be a moist, soft, slippery, and potentially viscous substance used by children for enjoyment and recreation.

The term “stereoscopy” (also called stereoscopics, or stereo imaging) is a technique for creating or enhancing the illusion of depth in an image by means of stereopsis for binocular vision.

Although the term “three-dimensional” is used, the presentation of dual two-dimensional images to elicit the illusion of a three-dimensional object is distinctly different from displaying an image in three full dimensions. The observer's head and eye movement will change information received about the objects being viewed, which can add to a child's play experience. Stereoscopic viewing may be artificially created by the viewer's brain, as demonstrated with the “Van Hare Effect”, where the brain perceives stereo images even when the paired photographs are identical. This false dimensionality results from the developed stereoacuity in the brain, allowing the viewer to fill in depth information even when few if any three-dimensional cues are actually available in the paired images.

The “scope” of the present invention is defined by the appended claims, along with the full scope of equivalents to which such claims are entitled. The scope of the invention is further qualified as including any possible combination of any of the aspects of any of the embodiments disclosed to result in additional embodiments, combinations, subcombinations, or the like that would be obvious to those skilled in the art.

What is claimed is:

1. A play compound comprising:
additives, which when viewed through a polarizing filter, elicit three-dimensional stereoscopic illusions.

2. The play compound of claim 1 further comprising a play compound component selectively added to provide a tactile effect.

3. The play compound of claim 1 further comprising a play compound component selectively added to provide an additional visual effect, said additional visual effect selected from the group consisting of:
a change of color;
an increase or decrease in color contrast between objects placed within the play compound;
an increase or decrease in a reflectivity of the play compound; and
emission of light from a phosphor.

4. The play compound of claim 1 wherein the play compound is formed from a mixture comprising powder and water.

5. The play compound of claim 4 wherein the powder comprises a gum.

6. The play compound of claim 4 wherein the powder comprises a borate.

7. The play compound of claim 4 wherein the powder comprises a colorant.

8. The play compound of claim 4 wherein the powder comprises a starch.

9. The play compound of claim 4 wherein the powder comprises a phosphate.

10. The play compound of claim 4 wherein the powder comprises an ethanol.

11. The play compound of claim 4 wherein the powder comprises an acetate.

12. A method of play comprising:
viewing a play compound with additives, which when viewed through a filter, elicit three-dimensional stereoscopic illusions through a polarizing filter.

13. The method of claim 12 wherein the filter is included in eyewear.

14. The method of claim 13 wherein there are two filters, and each of the two filters are configured to filter light based on:
(a) a color and/or wavelength of the light; and/or
(b) application of linear and/or circular polarization techniques.

15. The method of claim 13 further comprising adding glitter to the play compound.

16. The method of claim 13 further comprising salvaging collectables from the play compound.

17. A kit comprising:
the play compound of claim 1;
at least one pair of 3D glasses having at least two distinct filters for filtering light;
product packaging for storing the play compound between play sessions; and
instructions, warnings, images, and/or source/product identifiers printed on the product packaging.

18. The kit of claim 17 wherein the product packaging further includes a handle.

19. A method of manufacturing a play compound comprising manufacturing the play compound of claim 1.

20. The method of claim 19, further comprising determining set percentages for components and/or factory conditions for said manufacture.
